(19) United States
(12) Patent Application Publication
(10) Pub. No.: US 2002/0154068 A1
(43) Pub. Date: Oct. 24, 2002

(54) Add-on display for fuel dispenser

(76) Inventors: Jonathan A. Gromatzky, Kernersville, NC (US); Joseph D. Long, Greensboro, NC (US)

Correspondence Address: WITHROW & TERRANOVA, P.L.L.C., P.O. BOX 1287, CARY, NC, 27512, US

(21) Appl. No.: 09/840,642

(22) Filed: Apr. 23, 2001

(51) Int. Cl. G09G 5/00

(52) U.S. Cl. 345/1.1

(57) ABSTRACT

The present invention is related to a display that is added-on to a fuel dispenser for displaying information to a user of the fuel dispenser and that meets regulatory guidelines. An display attached to an arm is added on to a fuel dispenser. The arm contains wiring to couple the display to the electronics and/or control system inside the fuel dispenser. The arm is configured so that the wiring does not go through or cross a classified area of the fuel dispenser so that special potting and/or conduits are not required on the arm for the wiring.

### FIELD OF THE INVENTION

The present invention is related to a display that is added-on to a fuel dispenser for displaying information to a user of the fuel dispenser and that meets regulatory guidelines.

### BACKGROUND OF THE INVENTION

Fuel dispensers are now starting to incorporate graphical displays for presentation of information to users of fuel dispensers during refueling of vehicles. Fuel dispensers now include functionalities that require more involvement from the user, such as use of credit card for payment of fuel. For example, Marconi Commerce Systems, the assignee of the present application, markets an Infoscreen® monitor that, in at least one configuration, is 5.7″ in size. The Infoscreen® displays instructions and other information to the user of the fuel dispenser to carry out a fueling transaction.

Fuel dispensers include numerous internal components, including, but not limited to, electronics, valves, conduits, pumps, meters, hoses, nozzles and the like. It may be desirable to include a larger display in a fuel dispenser than is currently available, but packaging constraints may prevent this display from easily be included inside the fuel dispenser. In addition, many fuel dispenser manufacturers would like to market displays that are independent of the original manufacture of the fuel dispenser so that these display may be placed on other brands of fuel dispensers.

Fuel dispensers are also classified as devices having hazardous area since fuel dispensers handle explosive fuel. It is a requirement in the National Electric Code (NEC), Section 500, that electronic devices, or devices that may cause a spark to ignite fuel in a fuel dispenser be properly installed according to division classifications. The area of the fuel dispenser that carries fuel is rated as a hazardous area. The areas immediate surrounding areas of the fuel delivery path are classified as class one, division one areas. An example of a class one, division one area is the outside vertical columns on a H-frame style fuel dispenser that contain conduits that carry fuel to the top of the dispenser to be dispensed through a hose and nozzle to a vehicle. The electronics compartment of the fuel dispenser is often located inside the outside columns and is a non-classified area if properly separated from classified areas of the fuel dispenser. Any display mounted on the outside of the fuel dispenser is typically connected to the electronics compartment of the fuel dispenser to control the display.

Because an electronic device, such as a display added to a fuel dispenser, cannot cross a class one, division one area of a fuel dispenser unless proper potting and/or conduits are provided as provided in Section 501 of the NEC, there exists a need to find another solution to adding on displays to fuel dispensers that comply with the NEC.

### SUMMARY OF THE INVENTION

The present invention is related to a display that is added-on to a fuel dispenser for displaying information to a user of the fuel dispenser and that meets regulatory guidelines.

A display is added onto the outside an existing fuel dispenser. An arm is used to hold the display, and the display is securely affixed to the arm. Wired connections are run from the control system to the display through a conduit located inside the arm the arm in a conduit. The arm is connected around the columns of the fuel dispenser, a class one, division one area, to the top of the electronics compartment of the fuel dispenser that houses the control system. In this manner, the arm and the wiring connecting the display and the control system do not cross a classified area such that special potting or conduits are not needed in the wiring connections from the arm to the display, or the arm to the control system.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is a schematic diagram of a fuel dispenser with an add-on display according to the present invention; and

FIG. 2 is a schematic diagram of one embodiment of a block diagram illustrating the display and control system architecture of a fuel dispenser.

### DETAILED DESCRIPTION OF THE PREFERRED EMBODIMENTS

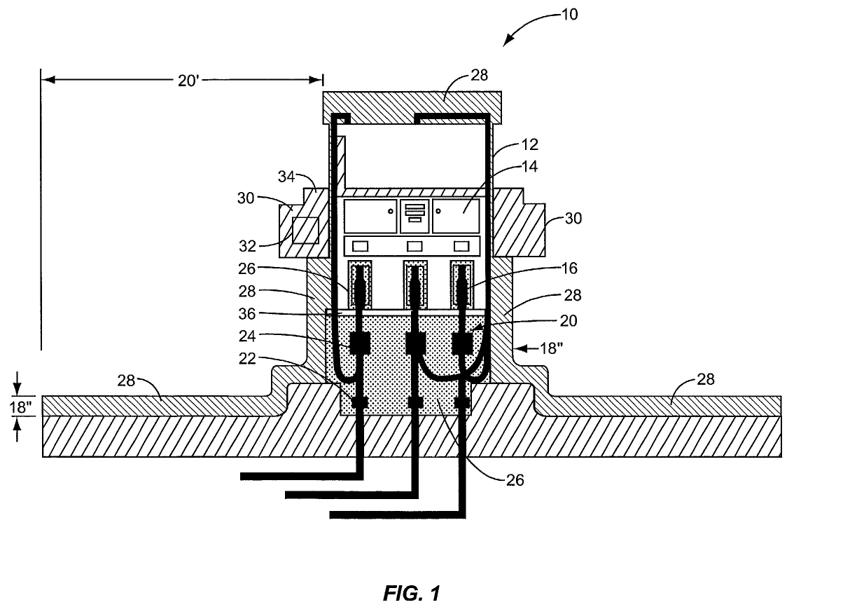

FIG. 1 illustrates a fuel dispenser 10 according into the present invention. The fuel dispenser 10 is comprised of a housing 12 that is usually constructed out of sheet metal. The fuel dispenser 10 contains a control system 14 that is usually comprised of electronics and software to control the operation the fuel dispenser 10, including the dispensing of fuel through a hose 16 and nozzle 18. Fuel from the underground storage tanks at a service station (not shown) are routed into the branch conduit's 15 into individual fuel dispenser's 10 hydraulics 20 for dispensing into a vehicle (not shown).

Fuel (not shown) enters the fuel dispenser 10 at its base and is controlled by a control valve 22 under control of the control system 14. The fuel delivery path passes through the control valve 22 and passes through a meter 24 for measurement purposes. The fuel is then delivered to the hose 16 and nozzle 18 for delivery into a vehicle.

Fuel dispensers 10 are classified as hazardous devices according to the National Electric Handbook (NEC). Any part of the fuel dispenser 10 that handles fuel directly is classified as a hazardous area 25. Areas of the fuel dispenser that immediately surround the hazardous areas 25 in the fuel dispenser 25 are called Class 1, Division 1 areas 26. Electronics and other devices that make calls a spark or involve electricity in any manner are not allowed to be placed into the hazardous area and are not allowed to be placed in Class 1, Division 1 Very 26 unless certain proper precautions are taken according to the NEC. Areas that immediately surround the class one, division one areas of the fuel dispenser 10 without additional measures are classified as class one, division two areas 28. FIG. 1 illustrates the class one, division two areas 28 of the fuel dispenser 10 as 18 inches away from the class one, division one areas 28 extending up to 20 feet out from the fuel dispenser 10. For more information on classifications of fuel dispensers 10, see U.S. Pat. No. 5,717,564 entitled “Fuel pump wiring,” incorporated herein by reference in its entirety.

The fuel dispenser 10 contains a vapor barrier 36 in the form of an air gap that provides a proper barrier between the unclassified area 29 and the class 1, division 1 area 26 that contains the hydraulics 20, and as disclosed in in U.S. Pat. No. 4,984,445 entitled “Gasoline dispenser with valve control through an air gap” assigned to the same assignee as present invention and incorporated herein by reference in its entirety.

A display 30 is attached on each side of the fuel dispenser 60, such as the display described in co-pending patent application Ser. No. ______ entitled “Multiple browser interface,” filed on Apr. 23, 2001, assigned to the same assignee of the present invention, and incorporated herein by reference in its entirety. The display 30 on the left side of the fuel dispenser 60 in FIG. 1 faces the visible fueling position. The display 30 on the right side of the fuel dispenser 60 facing the fueling position on the opposite side of the fuel dispenser illustrated in FIG. 1.

In order for the display 30 to provide information to a user of the fuel dispenser 60, the display 30 may be controlled by a control system 14 inside the fuel dispenser 10. The display 30 is coupled to the control system 14 using wired connections. In one embodiment, the display 30 may contain a browser software. For more information on browsers in fuel dispensers, see U.S. Pat. No. 6,052,629 entitled “Internet capable dispenser architecture,” incorporated herein by reference in its entirety.

When attaching the display 30 to the fuel dispenser 10, a physical connection is made between the display 30 and the control system 14 if this coupling is through wire connection. In addition, the display 30 must be affixed to a fuel dispenser 60 and secure manner. To accomplish this, an arm 34 is provided to attach to the display 30 and also provide a conduit for wiring for connection to the control system 14. In order to meet the NEC guidelines, an electronic device must not cross a Class 1 Division 1 area 26 unless proper precautions are taken. By the word “cross,” is meant that the wiring connections or other electronic or current carrying devices are placed or go through the class 1, division 1 area 26. As illustrated FIG. 1, the displays 30 are located right beside the columns 13 which are classified as a class one, division one area 26. Therefore, the display 30 couplings to the control system 14 must not pass through the columns 13 unless proper potting and/or conduits are used as required in the NEC.

The invention involves the need to pass the wiring couplings to the control system 14 so that they do not pass through the class one, division one area 26. The arm 34 with the wiring couplings is configured to wrap around or avoiding entering the columns 13 of the fuel dispenser 10 so that the wiring couplings do not pass through a classified area of the fuel dispenser 60. The arm rests of the top 17 of the fuel dispenser electronics cabinet, and the wirings exit the arm 34 and go into the top 17 to couple to the control system 14. Note that the arm 34 may not have to wrap around the columns 13 of the fuel dispenser 10 if the column 13 widths do not extend full out to outer edges of the fuel dispenser 60. In this manner an arm 34 may be able to extend straight, without any bends, from the top 17 to the outside of the fuel dispenser 10 with the display 30 is desired for mounting.

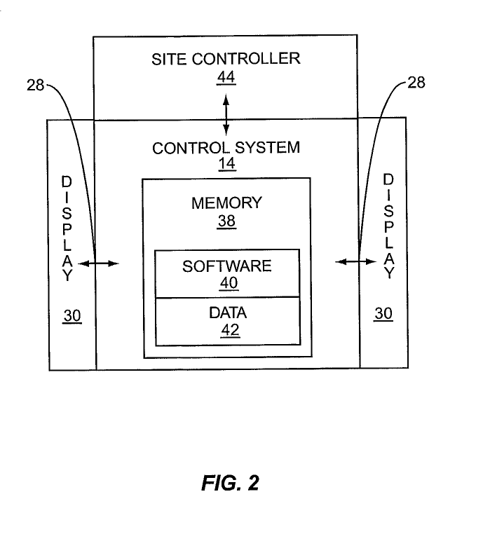

FIG. 2 illustrates a block diagram of the electronics architecture of the fuel dispenser illustrate FIG. 1. The control system 14 may contain a microprocessor (not shown) and the memory 38. The memory 38 contains program software 40 and data 42 for executing instructions by the microprocessor. Additionally, the control system 14 may communicate to a site controller 44. The site controller may be a server, a point-of-sale system, or both. The site controller 44 provides overall control to the control system 14 for the operation of the fuel dispenser 10. For example, credit card information used for payment of fuel at a fuel dispenser 60 may be passed from the card reader (not shown) on the fuel dispenser to the control system 14 and on to the site controller 44 for authorization. The site controller 44 may communicate back to the control system 14 to indicate the credit card information has been accepted and fueling is approved.

The embodiments set forth above represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Those skilled in the art will recognize improvements and modifications to the preferred embodiments of the present invention. All such improvements and modifications are considered within the scope of the concepts disclosed herein and the claims that follow.

What is claimed is:

1. A fuel dispenser for dispensing fuel to a vehicle, comprising:
a housing surrounded by a class one, division two area;
a control system;
a hose;
a nozzle attached to said hose;
a hydraulics comprising at least one meter and one valve in a class one, division one area of the fuel dispenser wherein said hydraulics is under control of said control system to dispense fuel through said hose and said nozzle to the vehicle; and
a display located outside of said housing and coupled to said control system by crossing only said class one, division two area of the fuel dispenser for displaying information at the fuel dispenser;

2. The fuel dispenser of claim 1, wherein said display contains a LCD module for displaying information at the fuel dispenser.

3. The fuel dispenser of claim 1, wherein said display is attached to said housing using an arm.

4. The fuel dispenser of claim 4, wherein said arm has a conduit for wires to couple said display to said control module.

5. The fuel dispenser of claim 1, wherein said display is coupled to said control system using a conduit comprising wiring to connect said display to said control system.

6. The fuel dispenser of claim 1, wherein said display is comprised of two displays wherein one of said two displays faces a first fueling position and the other display of said two displays faces a second fueling position.

7. The fuel dispenser of claim 1, further comprising a vapor barrier between said hydraulics and said control system.

8. The fuel dispenser of claim 7, wherein said vapor barrier is an air gap.

9. The fuel dispenser of claim 1, wherein said display is a client.

10. A fuel dispenser for dispensing fuel to a vehicle, comprising:
a housing surrounded by a class one, division two area;
a control system coupled to a site controller;
a hose;
a nozzle attached to said hose;
a hydraulics comprising at least one meter and one valve in a class one, division one area of the fuel dispenser wherein said hydraulics is under control of said control system to dispense fuel through said hose and said nozzle to the vehicle; and
a display located outside of said housing and attached to said housing by crossing only said class one, division two area of the fuel dispenser for displaying information at the fuel dispenser.

11. The fuel dispenser of claim 10, wherein said display is coupled directly to said site controller.

12. The fuel dispenser of claim 10, wherein said site controller is a server.

13. The fuel dispenser of claim 10, wherein said display is a client.

14. The fuel dispenser of claim 10, wherein said display contains a LCD module for displaying information at the fuel dispenser.

15. The fuel dispenser of claim 10, wherein said display is attached to said housing using an arm.

16. The fuel dispenser of claim 15, wherein said arm has a conduit for wires to couple said display to said control module.

17. The fuel dispenser of claim 10, wherein said display is coupled to said control system using a conduit comprising wiring to connect said display to said control system.

18. The fuel dispenser of claim 10, wherein said display is comprised of two displays wherein one of said two displays faces a first fueling position and the other display of said two displays faces a second fueling position.

19. The fuel dispenser of claim 10, further comprising a vapor barrier between said hydraulics and said control system.

20. The fuel dispenser of claim 19, wherein said vapor barrier is an air gap.

21. The method of attaching a separate display module to a fuel dispenser, comprising the steps of:
attaching a separate display to a housing on the fuel dispenser having a class one, division one area and a class one, division two area;
providing a conduit between said display and a control system in said housing by only crossing said class one, division two area; and
coupling said display to a control system in the fuel dispenser.

22. The method of claim 21, wherein said control system is inside said housing.

23. The method of claim 22, wherein said control system is coupled to a site controller.

24. The method of claim 21, wherein said control system is located outside of said housing.

25. The method of claim 24, wherein said control system is a site controller.

26. The method of claim 24, wherein said control system is a server.

27. The method of claim 21, wherein said display is coupled to said control system using a wired connection.

28. The method of claim 21, wherein said display is coupled to said control system using a wireless connection.
